(19) United States
(12) Patent Application Publication
(10) Pub. No.: US 2012/0048707 A1
(43) Pub. Date: Mar. 1, 2012

(54) Tactile Switch and Method for Manufacturing Tactile Switch

(76) Inventors: Tetsuya Nakamura, Tokyo (JP); Toshihiko Terashita, Tokyo (JP); Tadahiko Tsutsui, Tokyo (JP); Mitsunori Kumagai, Tokyo (JP); Hayato Fujikawa, Tokyo (JP)

(21) Appl. No.: 13/212,303

(22) Filed: Aug. 18, 2011

(30) Foreign Application Priority Data
Aug. 31, 2010 (JP) P2010-193982

(51) Int. Cl. H01H 1/10; H01H 11/00

(52) U.S. Cl. 200/517; 29/622

(57) ABSTRACT

A tactile switch includes a base, an elastic conductive member, and a cover sheet. A fixed contact is provided in the base. The elastic conductive member, has a dome shape, opposes the fixed contact, and is elastically deformed to be electrically conducted with the fixed contact. The cover sheet covers the elastic conductive member. An operating protrusion is provided on a face of the cover sheet at a position corresponding to the fixed contact. The operating protrusion includes an end part, a root part of fixed to the cover sheet and having a diameter larger than a diameter of the end part, and a bent part connecting the end part to the root part so that a first angle formed by a side wall of the root part with respect to the face of the cover sheet is smaller than a supplementary angle of a second angle formed by a side wall of the end part with respect to the face of the cover sheet.

### BACKGROUND

The present invention is related to a tactile switch used in various kinds of electronic devices and a method for manufacturing the tactile switch.

A tactile switch is known as a signal input device used in a compact and thin electronic device such as a cellular phone. In the tactile switch, since the thickness can be reduced, a good sense of operation can be obtained during an operation and an electrically stable contact can be obtained, the tactile switch is frequently used in the compact and thin electronic device.

As such a tactile switch, a push switch disclosed in patent literature 1 is known. A push switch 201 disclosed in the patent literature 1 includes, as shown in FIG. 6, a fixed contact 202, a housing 203 having an accommodating space 203a, a dome shaped movable contact 204 accommodated in the accommodating space 203a so that its center is opposed to the fixed contact 202 and a flexible sheet 205 held on the movable contact 204 by an adhesive layer 207. The push switch 201 includes an operating force concentrating member (an operating protrusion) 206 at a position of the movable contact 204 opposed to the fixed contact 202 in order to concentrate a pressure operating force applied to the movable contact 204 on the central part of the movable contact 204. The operating force concentrating member 206 is inserted into a hollow positioning protrusion 205a of the flexible sheet 205 which is formed at a position overlapped on the central part of the movable contact 204 and the adhesive layer 207 adheres thereto.

The positioning protrusion 205a of the push switch 201 disclosed in the patent literature 1 is formed so as to rise substantially at orthogonal to the flexible sheet 205. Accordingly, when the push switch 201 is pressed and operated to elastically deform the dome shaped movable contact 204, a stress is concentrated on a corner part 205b in which the positioning protrusion 205a rises from the flexible sheet 205 to generate a large distortion in the corner part 205b. Thus, when pressing operations are repeated many times, cracks are generated in the corner part 205b, and the cracks shortly expand, so that there is a fear that the operating force concentrating member 206 may possibly slip out from the flexible sheet 205 to shorten the life of the push switch 201.
[Patent Literature 1] Japanese Patent Publication No. 2009-140711 A

### SUMMARY

It is therefore one advantageous aspect of the present invention to provide a tactile switch having a long life by preventing an operating protrusion from slipping out and a method for manufacturing a tactile switch.

According to one aspect of the invention, there is provided a tactile switch, comprising:

a base, in which a fixed contact is provided;

an elastic conductive member, having a dome shape, opposing the fixed contact, and configured to be elastically deformed to be electrically conducted with the fixed contact;

a cover sheet, covering the elastic conductive member; and

an operating protrusion, provided on a face of the cover sheet at a position corresponding to the fixed contact, and including:
an end part;
a root part fixed to the cover sheet and having a diameter larger than a diameter of the end part; and
a bent part connecting the end part to the root part so that a first angle formed by a side wall of the root part with respect to the face of the cover sheet is smaller than a supplementary angle of a second angle formed by a side wall of the end part with respect to the face of the cover sheet.

The end part, the root part and the bent part may be integrally formed.

A radius of curvature of the bent part may be equal to or larger than 0.025 mm and equal to or smaller than 0.035 mm.

The first angle may equal to or larger than 15 degrees and equal to or smaller than 25 degrees.

A surface roughness of the face of the cover sheet may be equal to or more than 0.30 μm and equal to or less than 0.36 μm.

According to another aspect of the invention, there is provided a method for manufacturing a tactile switch including:

a base, in which a fixed contact is provided;

an elastic conductive member, having a dome shape, opposing the fixed contact, and configured to be elastically deformed to be electrically conducted with the fixed contact;

a cover sheet, covering the elastic conductive member; and an operating protrusion, provided on a face of the cover sheet at a position corresponding to the fixed contact, and including:
an end part;
a root part fixed to the cover sheet and having a diameter larger than a diameter of the end part; and
a bent part connecting the end part to the root part so that a first angle formed by a side wall of the root part with respect to the face of the cover sheet is smaller than a second angle which is a supplementary angle of an angle formed by a side wall of the end part with respect to the face of the cover sheet,

the method comprising:

disposing a nozzle of a discharge port supplying a resin forming the operating protrusion at a position close to the face of the cover sheet;

discharging the resin from the nozzle to form a resin portion on the face so that the nozzle is inside of the resin portion;

lifting the nozzle from the resin portion;

providing a plate on an upper face of the resin portion; and

curing the resin while holding the plate at a predetermined height from the face.

A roughening process may be applied to the face of the cover sheet so that a surface roughness is equal to or more than 0.30 μm and equal to or less than 0.36 μm.

After the plate is provided on the upper face of the resin portion, the plate may be lifted to lift the resin.

### BRIEF DESCRIPTION OF DRAWINGS

FIG. 1 is an exploded perspective view of a tactile switch according to an embodiment of the present invention.

FIG. 2 is a sectional view of the tactile switch shown in FIG. 1.

FIG. 3 is an enlarged sectional view of a main part of a cover sheet of the tactile switch shown in FIG. 1.

FIGS. 4A to 4E are schematic views showing a manufacturing method of the cover sheet shown in FIG. 3.

FIGS. 5A to 5C are schematic views showing a manufacturing method of a cover sheet according to a comparative example.

FIG. 6 is a sectional view of a tactile switch according to a usual example.

### DETAILED DESCRIPTION OF EXEMPLIFIED EMBODIMENTS

A tactile switch according to an embodiment of the present invention will be described below by referring to the drawings.

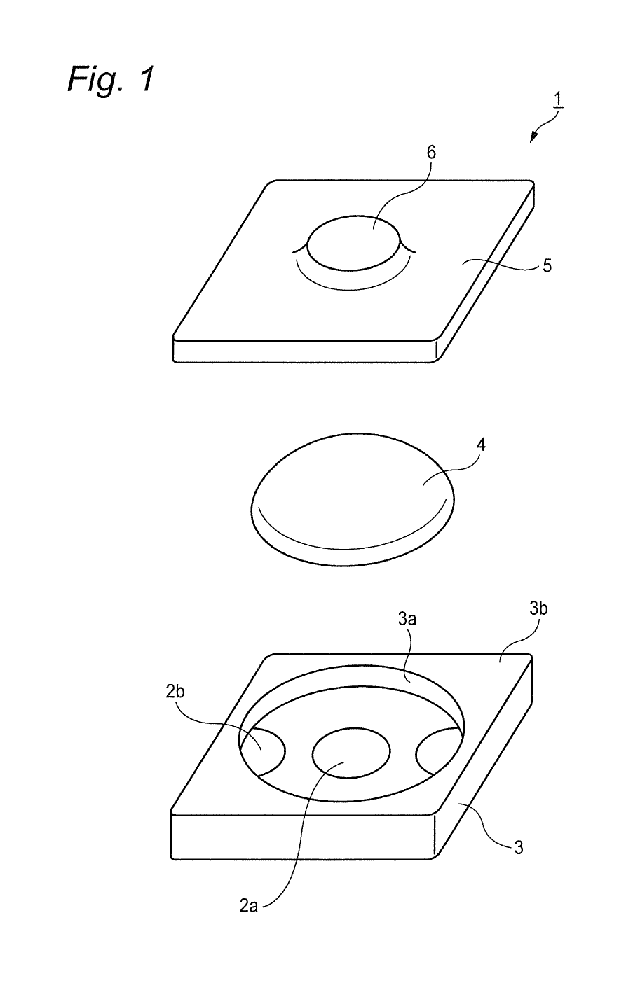

FIG. 1 is an exploded perspective view of a tactile switch 1 according to the present embodiment. As shown in FIG. 1, the tactile switch 1 includes a base part 3 having an accommodating recessed part 3a opened to an upper part, a central fixed electrode 2a and peripheral fixed electrodes 2b (fixed contacts) fixed to a bottom surface of the accommodating recessed part 3a, a dome shaped click spring (an elastic conductive member) 4 accommodated in the accommodating recessed part 3a and arranged so as to protrude toward an opened surface side of the accommodating recessed part 3a and a cover sheet 5 that protects an upper surface 3b of the base part 3 and an upper part of the click spring 4.

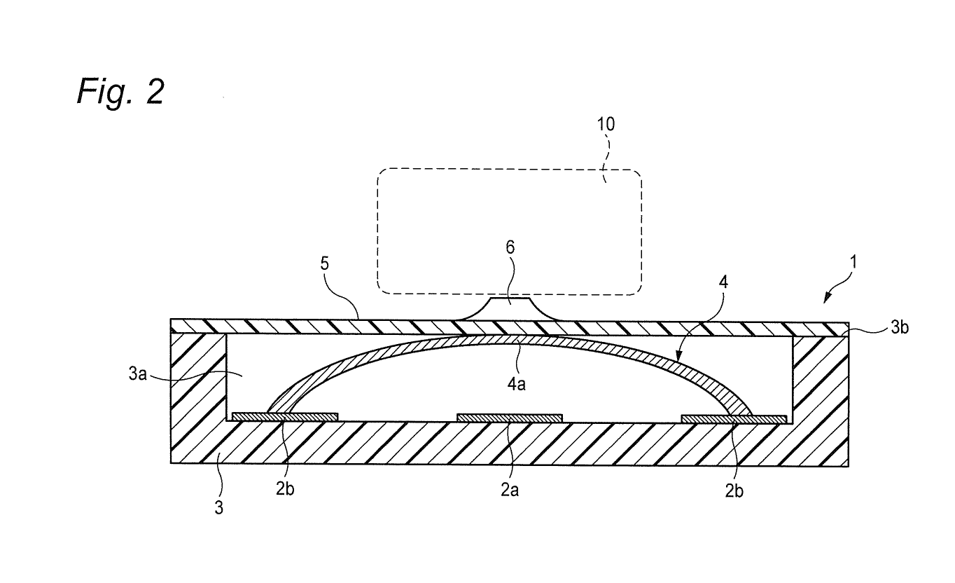

By referring to FIGS. 1 and 2, the base part 3 is a resin member of a substantially rectangular parallelepiped. In a center of an upper surface thereof, the accommodating recessed part 3a opened to the upper part is formed. In a center of the bottom surface of the accommodating recessed part 3a, the central fixed electrode 2a is provided and the peripheral fixed electrodes 2b are provided in peripheral areas spaced from the central fixed electrode 2a.

The click spring 4 made of metal is a member having a form of a dome protruding to an upper part and which can be elastically deformed. Further, at least a part of an end part of the click spring 4 comes into contact with the peripheral fixed electrodes 2b and is arranged in the recessed part 3a.

Under an ordinary state that any load is not externally applied to the click spring 4, a top part 4a of the click spring 4 is separated from the central fixed electrode 2a. Thus, the central fixed electrode 2a is not electrically conducted to the peripheral fixed electrodes 2b and the tactile switch 1 is in a state of OFF. On the other hand, under a state that the top part 4a of the click spring 4 is pressed downward, the click spring 4 is elastically deformed so that the top part 4a of the click spring 4 comes into contact with the central fixed electrode 2a. Thus, the central fixed electrode 2a is electrically conducted to the peripheral fixed electrodes 2b and the tactile switch 1 is in a state of ON.

The cover sheet 5 is a flexible insulating film provided on an upper part of the click spring 4. When the top part 4a of the click spring 4 is pressed, the cover sheer 5 is also elastically deformed so as to protrude downward in accordance with the deformation of the click spring 4. Further, the cover sheet 5 covers the base part 3 and the click spring 4 to prevent dust or water from entering the accommodating recessed part 3a of the base part 3 from an external part and prevent the corrosion of the click spring 4 or the central fixed electrode 2a and the peripheral fixed electrodes 2b.

The cover sheet 5 may be made of a resin such as polyimide. A back surface of the cover sheet 5 is bonded to the upper surface 3b of the base part 3 through an adhesive layer.

An operating protrusion 6 is formed at a position of a substantially central part of a surface of the cover sheet 5 and corresponding to the central fixed electrode 2a. The operating protrusion 6 is provided so as to protrude to an opposite side to the click spring 4 from the surface of the cover sheet 5. The operating protrusion 6 is a member including an end part 6a whose end is a flat surface, a root part 6b fixed to the cover sheet 5 and having a diameter larger than that of the end part 6a and a bent part 6c that connects the end part 6a to the root part 6b. The end part 6a, the root part 6b and the bent part 6c are integrally formed. Further, the operating protrusion 6 is formed in the shape whose diameter is gradually enlarged from the end part 6a to the root part 6b.

When the top part 4a of the click spring 4 is pressed to turn on the tactile switch 1, a pressing member 10 having a large pressing area such as a button presses the top part 4a of the click spring 4 through the end part 6a of the operating protrusion 6 having a small area. Thus, a pressing force by the pressing member 10 is concentrated on the top part so that a large stress may be applied to the top part 4a of the click spring 4. Accordingly, even when relative positions of the pressing member 10 and the tactile switch 1 are slightly shifted, a pressing operation can be assuredly realized.

When the top part 4a of the click spring 4 is pressed, since the cover sheet 5 is also elastically deformed to protrude downward in accordance with the click spring 4, if the root part 6b that connects the operating protrusion 6 to the cover sheet 5 is not elastically deformed in accordance therewith, the stress concentrates on the root part 6b. In this point, when the thickness of the root part 6b is large, its rigidity is high, so that the root part 6b cannot be greatly elastically deformed so as to follow the elastic deformation of the cover sheet 5. On the other hand, when the thickness of the root part 6b is small, rigidity is low, so that the root part 6b can easily follow the elastic deformation of the cover sheet 5. Namely, when a wide area of the root part 6b can be elastically deformed so as to follow the elastic deformation of the cover sheet 5, a concentration of stress on the root part 6b can be mitigated and the occurrence or expansion of cracks can be suppressed.

Thus, in the present embodiment, in order to ensure widely an area of the root part 6b having a small thickness in a diametrical direction, a basic angle A1 of the root part 6b of the operating protrusion 6 is set to be smaller than an end angle A2 of the end part 6a. When the basic angle A1 of the root part 6b is small, since the area of the root part 6b having the small thickness can be widely ensured in the diametrical direction and the large area is elastically deformed so that the concentration of stress may be suppressed, the occurrence or expansion of the cracks can be suppressed in the root part 6b. Since the concentration of stress does not occur in the end part 6a, a side wall of the end part 6a may have a sharp form (a form having a large end angle A2).

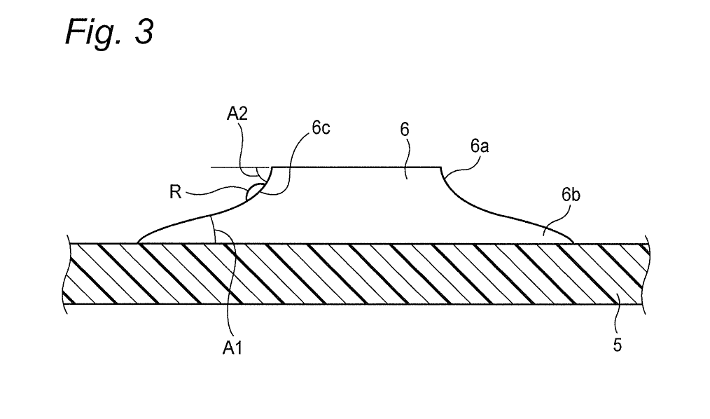

The basic angle A1 mentioned herein is, as shown in FIG. 3, an angle formed by the side wall of the root part 6b relative to the surface of the cover sheet 5. The end angle A2 is a supplementary angle of an angle formed by the side wall of the end part 6a relative to the surface of the cover sheet 5. In the this embodiment, the root part 6b is connected to the end part 6a by the bent part 6c and the basic angle A1 is made to be different from the end angle A2. When a side surface of the end part 6a or the root part 6b is a curved surface, a supplementary angle of an angle formed by a main part of the end part 6a relative to the surface of the cover sheet 5 is defined as the end angle A2 and an angle formed by a main part of the root part 6b relative to the surface of the cover sheet 5 is defined as the basic angle A1.

In a truncated cone shaped operating protrusion including a root part and an end part with a basic angle A1 equal to an end angle A2 that are formed in a straight line, which is different from the present embodiment, when the basic angle A1 is tried to decrease, the operating protrusion becomes too large in a diametrical direction. Thus, an original purpose that the pressing force is to be concentrated cannot be achieved. Further, when the basic angle A1 is increased, the operating protrusion is liable to be separated from the cover sheet.

The basic angle A1 of the operating protrusion in the present embodiment is preferably set to an angle of 15° or more and smaller than 25°. When the basic angle A1 is smaller than 15°, the thickness of the root part 6b is too small, so that the cracks are apt to occur due to an excessively small thickness. Further, when the basic angle A1 is larger than 25°, the thickness of the root part 6b is large, so that the root part 6b is hardly elastically deformed and the cracks are apt to occur.

When the end part 6a, the root part 6b and the bent part 6c are integrally formed with the same material, since interfaces are not generated respectively between the parts 6a to 6c, the cracks are more effectively prevented from occurring in the operating protrusion 6.

Further, a boundary of the end part 6a and the root part 6b is preferably connected by the bent part 6c having a smooth curved surface with a radius of curvature of 0.025 mm or larger and 0.035 mm or smaller. In the present embodiment, since the basic angle A1 of the root part 6b is made to be different from the end angle A2 of the end part 6a, the bent part 6c is formed in the boundary of the root part 6b and the end part 6a. When the radius of curvature R of the bent part 6c is set to 0.025 mm or larger and 0.035 mm or smaller, the concentration of stress on the bent part 6c can be suppressed and the occurrence and expansion of the cracks can be suppressed.

As described above, the basic angle A1 of the root part 6b is set to be smaller than the end angle A2 of the end part 6a. Thus, even when the cover sheet 5 is elastically deformed together with the click spring 4, since the basic angle A1 of the operating protrusion 6 is small, the stress is hardly concentrated on the root part 6b of the operating protrusion 6. Accordingly, the cracks hardly occur in the root part 6b of the operating protrusion 6 and the operating protrusion 6 is hardly peeled off. Therefore, the tactile switch 1 having a long life can be provided.

In the above-described embodiment, the operating protrusion 6 is provided in the opposite side to the click spring 4, however, the operating protrusion 6 may be provided in the same side as the click spring 4. Also in this case, since the pressing force can be concentrated on the top part 4a of the click spring 4, a good sense of operation can be obtained.

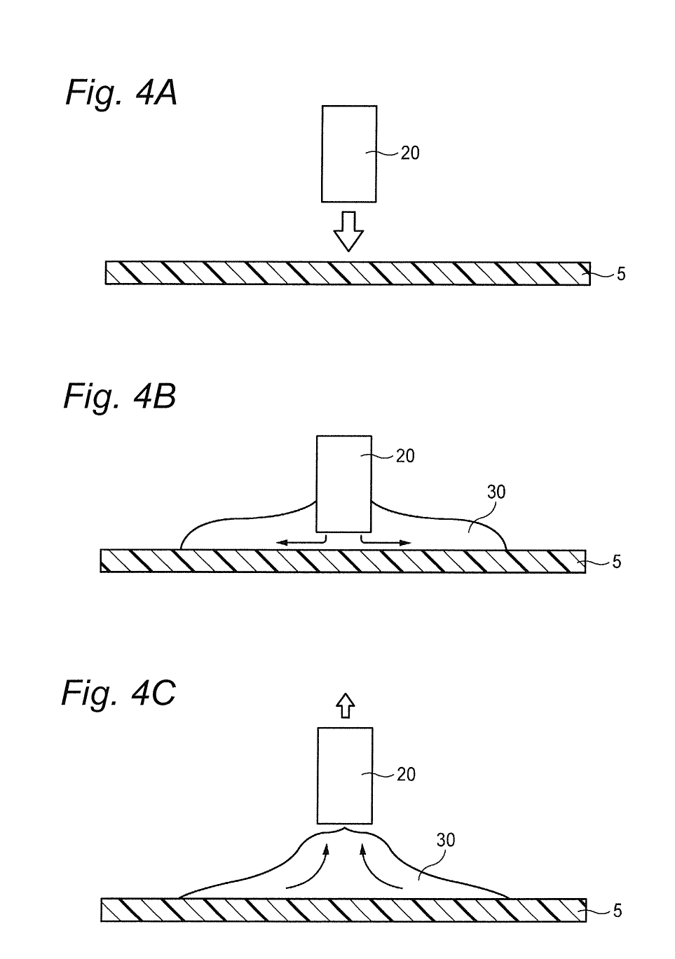

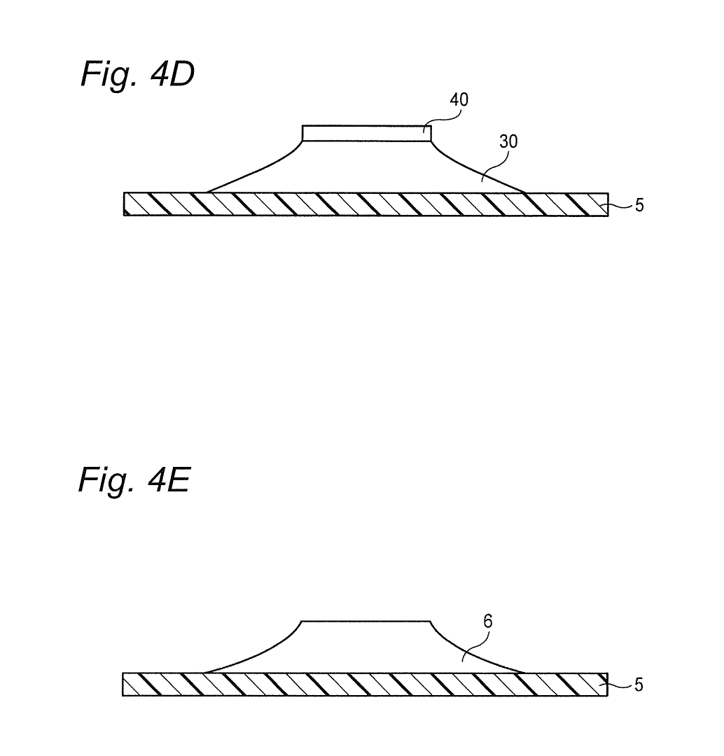

A manufacturing method of the tactile switch 1 will be described below. FIGS. 4A to 4E are diagrams especially showing manufacturing processes of the operating protrusion 6. The operating protrusion 6 is provided on a polyimide tape forming the cover sheet 5.

Initially, as shown in FIG. 4A, a discharge port of a nozzle 20 is allowed to come close to the surface of the cover sheet 5. The nozzle 20 serves to supply a liquid material resin such as an ultraviolet setting resin as a material of the operating protrusion 6 to the surface of the cover sheet 5 from a supply source not shown in the drawing.

Then, as shown in FIG. 4B, under a state that the discharge port of the nozzle 20 is allowed to sufficiently come close to the surface of the cover sheet 5, the material resin is discharged from the nozzle 20 to form a resin portion 30 on the surface of the cover sheet 5. Since the material resin discharged from the discharge port of the nozzle 20 is blocked on the surface of the cover sheet 5 to spread in the radial direction on the surface of the cover sheet 5, the material resin can be efficiently spread on a wide area.

When an amount of the discharged material resin is the same, as a contact surface of the resin portion 30 to the cover sheet 5 is more increased, an area of the operating protrusion 6 having the small thickness is more increased. Thus, preferably, the operating protrusion 6 is easily elastically deformed. When a discharge pressure or a flow rate of the material resin and a space between the discharge port of the nozzle 20 and the surface of the cover sheet 5 are adjusted, a size of the bottom surface of the resin portion 30 can be adjusted.

Now, as shown in FIG. 4C, when the material resin is discharged from the discharge port of the nozzle 20 to form the resin portion so as to sink the discharge port of the nozzle 20 in the surface of the cover sheet 5, the discharge of the material resin is stopped to raise the discharge port of the nozzle 20 from the resin portion 30. At this time, the material resin adhering to an end of the nozzle 20 due to the viscosity of the material resin is also lifted upward in accordance with a lifting operation of the nozzle 20. As a result, a central area of the resin portion 30 is lifted upward and a peripheral area is also attracted to a central part. Accordingly, much material resin is gathered to the central area of the resin portion 30 as the end part 6a, so that the operating protrusion 6 can be formed in which the basic angle A1 of the root part 6b is smaller than the end angle A2 of the end part 6a.

Since a surface tension is applied to the resin portion 30, an angle formed by a terminal end (both ends of side parts in FIG. 4B) of a part forming the root part 6b of the operating protrusion 6 relative to the surface of the cover sheet 5 may be occasionally large. However, as described above, when the material resin is lifted upward by the lifting operation of the nozzle 20 as described above, since the peripheral area of the resin portion 30 is moved to the central area, the thickness of a terminal end area of the root part 6b of the operating protrusion 6 can be reduced. Thus, the operating protrusion 6 can be formed which is more hardly peeled off.

Subsequently, as shown in FIG. 4D, in order to form a flat end surface of the end part 6a of the operating protrusion 6, a pressing plate 40 having a flat bottom surface is overlaid on the resin portion 30 from an upper part and held for a prescribed time to heat or irradiate the material resin with ultraviolet rays and harden the material resin. As shown in FIG. 4E, when the material resin is hardened, and then, the pressing plate 40 is removed, the operating protrusion 6 can be formed on the surface of the cover sheet 5. At this time, when the pressing plate 40 is overlaid on the resin portion 30, and then, the pressing plate 40 is moved upward so as to temporarily lift the pressing plate, since the material resin has the viscosity, the material resin adheres to the bottom surface of the pressing plate 40 and an entire part of the material resin is lifted upward. Thus, as described above, the operating protrusion 6 can be preferably formed in which the basic angle A1 is small.

The cover sheet 5 having the operating protrusion 6 obtained in such a way is overlaid and bonded onto the upper surface of the base part 3 having the accommodating recessed part 3a in which the central fixed electrode 2a, the peripheral fixed electrodes 2b and the click spring 4 are accommodated. Thus, the tactile switch 1 of the above-described embodiment can be obtained.

As the material resin of the operating protrusion 6, a thermosetting resin, an ultraviolet setting resin, a polyimide resin or the like may be used. As a material of the cover sheet 5, an acrylic resin or a polyphenylene sulfide (PPS) resin, a liquid crystal polymer, a nylon resin and an a polyether ether ketone (PEEK) resin may be exemplified as well as the polyimide resin. When the polyimide resin excellent in its heat resistance is used among them, a solder re-flow method may be preferably applied to the tactile switch 1.

Further, according to the manufacturing method of the present embodiment, since the end part 6a, the root part 6b and the bent part 6c are integrally formed, the bent part 6c that continuously and smoothly connects the end part 6a to the root part 6b can be formed. Specifically, the bent part 6c can be formed which has a smooth curve with the radius of curvature R of 0.025 mm or larger and 0.035 mm or smaller. Accordingly, the occurrence and expansion of the cracks can be suppressed in the bent part 6c.

Before the resin portion 30 is formed on the surface of the cover sheet 5, the surface of the cover sheet 5 may be roughened by a roughening process such as a sand blasting method or a polishing method using a sand paper. For instance, when the roughening process is applied so that surface roughness Ra (an arithmetic mean roughness) is 0.30 μm or higher and 0.36 μm or lower, an adhesion of the cover sheet 5 to the operating protrusion 6 is preferably improved. Especially, when the sand blasting method is used for the roughening process, the rigidity of the cover sheet 5 is preferably reduced to obtain a light sense of operation of the tactile switch 1.

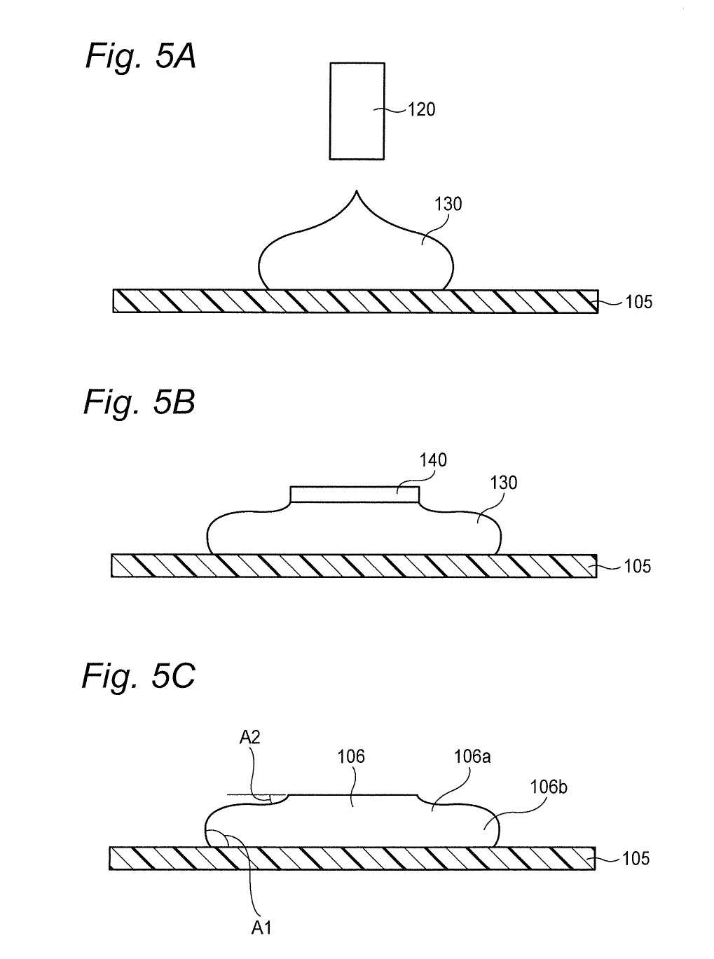

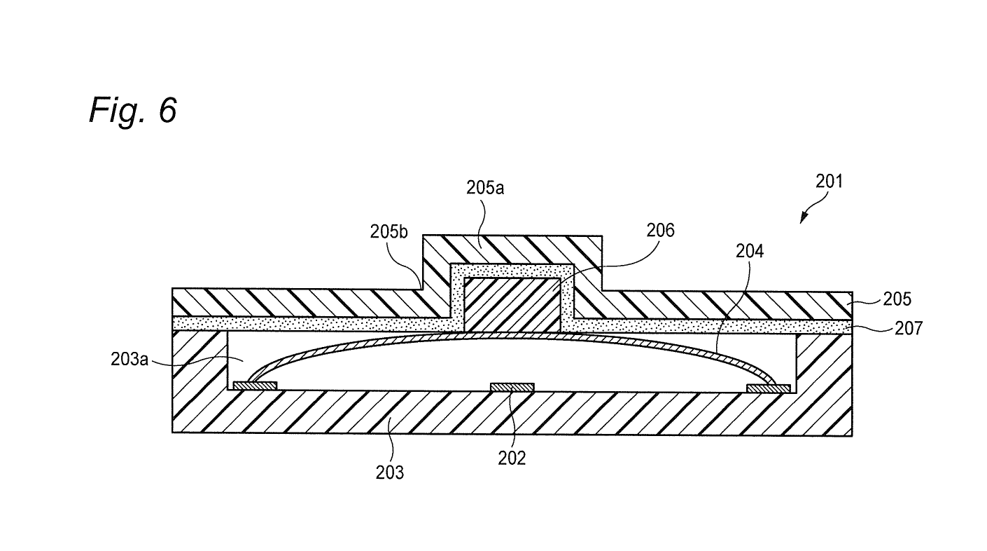

FIGS. 5A to 5C are schematic diagrams showing a method for forming an operating protrusion 106 according to a comparative example. In this comparative example, as shown in FIG. 5A, a discharge port of a nozzle 120 drops a material resin from the nozzle 120 at a position separating from a surface of a cover sheet 105 to form a liquid dam 130. As shown in FIG. 5B, a pressing plate 140 is overlaid on an upper surface of the resin portion 130 to form an end surface of an end part 106a of the operating protrusion 106. As shown in FIG. 5C, the material resin is hardened and the pressing plate 140 is removed to obtain the operating protrusion 106.

According to the above-described manufacturing method of the comparative example, since the material resin is merely dropped from the nozzle 120, the resin portion 130 does not greatly spread, so that the operating protrusion 106 having a large thick area is formed. Accordingly, a basic angle A1 of a root part 106b is larger than an end angle A2 of the end part 106a. Thus, since a large thin area that is easily elastically deformed is not formed in the operating protrusion 106, the operating protrusion 106 hardly follows the elastic deformation of the cover sheet 105 in accordance with an ON/OFF operation of a tactile switch and a stress is concentrated on a specific part of the operating protrusion 106. Accordingly, cracks occur and expand and the operating protrusion 106 is liable to be peeled off.

Further, according to the manufacturing method of the comparative example, since a process for lifting the material resin upward is not included, especially, the thin area is hardly formed in a peripheral edge part of the resin portion 130. Accordingly, since the root part of the operating protrusion 106 steeply rises from the surface of the cover sheet 105, the operating protrusion 106 formed by the manufacturing method according to the comparative example is liable to be separated from the surface of the cover sheet 105.

As described above, as compared with the method for forming the operating protrusion of the comparative example, according to the manufacturing method of the operating protrusion of the present embodiment, the thickness of the peripheral area of the resin portion 30 is reduced by the process for lifting the nozzle 20 from the resin portion 30 so that the basic angle A1 of the root part 6b may be smaller than the end angle A2 of the end part 6a. Accordingly, the root part 6b of the operating protrusion 6 can be easily elastically deformed in accordance with an ON/OFF operation of the tactile switch 1 and the stress can be restrained from being concentrated on the root part 6b to generate and expand the cracks.

Further, by the process that allows the end of the nozzle 20 to come close to the surface of the cover sheet 5, and then, forms the resin portion 30, the resin portion 30 can be formed to have a thin and large area and the area of the root part 6b of the operating protrusion 6 having the small thickness can be formed so as to be large. Accordingly, a large area of the operating protrusion 6 can be elastically deformed in accordance with the ON/OFF operation of the tactile switch 1 and the stress can be restrained from being concentrated on the root part to generate and expand the cracks.

A life test of the tactile switch 1 is carried out that is provided with the operating protrusion 6 formed by the manufacturing method according to the embodiment of the present invention shown in FIGS. 4A to 4E. A below-described life test is carried out for tactile switches of examples 1 to 3 in which the height of the operating protrusions 6 is set to 0.146 mm, a diameter of the root parts is fixed to 0.840 mm, diameters of end surfaces of end parts 6a of the operating protrusions 6 are made to be different and senses of operation (a sense of click) are made to be different. A time when the operating protrusions 6 are separated from cover sheets 5 is considered to be a completion of a test to evaluate the lives of the tactile switches according to the examples 1 to 3.

Further, as a comparative example 1, a tactile switch is manufactured that has an operating protrusion 6 formed by the manufacturing method shown in FIGS. 5A to 5C and compared with the above-described examples 1 to 3. Results of the life test are shown in Table 1.

TABLE 1

| | Diameter | basic | End | Radius of | |
|---|---|---|---|---|---|
| | of end | angle | angle | curvature of | |
| | surface | A1 | A2 | bent part | |
| | [mm] | [°] | [°] | [mm] | life |
| Example 1 | 0.384 | 15 to 18 | 75 to 90 | 0.028 | 300000 |
| | | | | | times or |
| | | | | | more |
| Example 2 | 0.461 | 19 to 20 | 45 to 60 | 0.029 to | 300000 |
| | | | | 0.032 | times or |
| | | | | | more |
| Example 3 | 0.531 | 18 to 21 | 45 to 80 | 0.027 to | 300000 |
| | | | | 0.037 | times or |
| | | | | | more |
| Comparative | No | No | No | No | 100000 |
| Example 1 | record | record | record | record | times |

As shown in the Table 1, as compared with the tactile switch according to the comparative example, it can be recognized that, in any of the tactile switches of the examples 1 to 3 having the different diameters of the end surfaces, even when pressing operations are repeated 300000 times or more, the operating protrusions 6 are not peeled off to provide the tactile switches having the long lives.

Since the basic angle A1 and the end angle A2 are uneven over an entire circumference of the operating protrusion 6, angles of the basic angle A1 and the end angle A2 are respectively expressed with ranges in the Table 1. Similarly, since the radius of curvature of the bent part is uneven in an entire circumference of the operating protrusion 6, the radius of curvature is also expressed with ranges.

According to the tactile switch of the present invention, the basic angle formed by the side wall of the root part of the operating protrusion relative to the surface of the cover sheet is smaller than the end angle as the supplementary angle of the angle formed by the side wall of the end part of the operating protrusion relative to the surface of the cover sheet. Thus, even when the cover sheet is elastically deformed together with the dome shaped elastic member, since the basic angle of the operating protrusion is small, the stress is hardly concentrated on the root part of the operating protrusion. Accordingly, the cracks hardly occur in the root part of the operating protrusion and the operating protrusion is hardly peeled off. Therefore, the tactile switch having a long life can be provided.

Further, according to the method for manufacturing the tactile switch according to the present invention, after the discharge port of the nozzle is allowed to come close to the surface of the cover sheet to discharge the material resin until the discharge port of the nozzle sinks in the resin portion, the nozzle is lifted from the resin portion. Thus, the material resin is lifted upward together with the nozzle so that a thin area which can be easily elastically deformed is readily formed in the peripheral part of the operating protrusion. Accordingly, the tactile switch having the long life can be provided in which the stress is hardly concentrated on the root part of the operating protrusion and the operating protrusion is hardly peeled off.

What is claimed is:

1. A tactile switch, comprising:
a base, in which a fixed contact is provided;
an elastic conductive member, having a dome shape, opposing the fixed contact, and configured to be elastically deformed to be electrically conducted with the fixed contact;
a cover sheet, covering the elastic conductive member; and
an operating protrusion, provided on a face of the cover sheet at a position corresponding to the fixed contact, and including:
an end part;
a root part fixed to the cover sheet and having a diameter larger than a diameter of the end part; and
a bent part connecting the end part to the root part so that a first angle formed by a side wall of the root part with respect to the face of the cover sheet is smaller than a supplementary angle of a second angle formed by a side wall of the end part with respect to the face of the cover sheet.

2. The tactile switch according to claim 1, wherein
the end part, the root part and the bent part are integrally formed.

3. The tactile switch according to claim 1, wherein
a radius of curvature of the bent part is equal to or larger than 0.025 mm and equal to or smaller than 0.035 mm.

4. The tactile switch according to claim 1, wherein
the first angle is equal to or larger than 15 degrees and equal to or smaller than 25 degrees.

5. The tactile switch according to claim 1, wherein
a surface roughness of the face of the cover sheet is equal to or more than 0.30 μm and equal to or less than 0.36 μm.

6. A method for manufacturing a tactile switch including:
a base, in which a fixed contact is provided;
an elastic conductive member, having a dome shape, opposing the fixed contact, and configured to be elastically deformed to be electrically conducted with the fixed contact;
a cover sheet, covering the elastic conductive member; and
an operating protrusion, provided on a face of the cover sheet at a position corresponding to the fixed contact, and including:
an end part;
a root part fixed to the cover sheet and having a diameter larger than a diameter of the end part; and
a bent part connecting the end part to the root part so that a first angle formed by a side wall of the root part with respect to the face of the cover sheet is smaller than a second angle which is a supplementary angle of an angle formed by a side wall of the end part with respect to the face of the cover sheet,
the method comprising:
disposing a nozzle of a discharge port supplying a resin forming the operating protrusion at a position close to the face of the cover sheet;
discharging the resin from the nozzle to form a resin portion on the face so that the nozzle is inside of the resin portion;
lifting the nozzle from the resin portion;
providing a plate on an upper face of the resin portion; and
curing the resin while holding the plate at a predetermined height from the face.

7. The method according to claim 6, wherein
a roughening process is applied to the face of the cover sheet so that a surface roughness is equal to or more than 0.30 μm and equal to or less than 0.36 μm.

8. The method according to claim 6, wherein
after the plate is provided on the upper face of the resin portion, the plate is lifted to lift the resin.
